(19) United States
(12) Patent Application Publication
(10) Pub. No.: US 2008/0258985 A1
(43) Pub. Date: Oct. 23, 2008

(54) Internal Antenna for Handset and Design Method Thereof

(75) Inventors: Byung-Hoon Ryou, Seoul (KR); Weon-Mo Sung, Gyeonggi-do (KR)

Correspondence Address: PATENTTM.US, P. O. BOX 82788, PORTLAND, OR, 97282-0788, US

(73) Assignee: E.M.W. ANTENNA CO., LTD., Seoul (KR)

(21) Appl. No.: 10/598,120

(22) PCT Filed: Feb. 18, 2005
(86) PCT No.: PCT/KR2005/000430

§ 371 Date: Jul. 10, 2008

(30) Foreign Application Priority Data
Feb. 19, 2004 (KR) 10-2004-0010972
Feb. 17, 2005 (KR) 10-2005-0013204

(51) Int. Cl. H01Q 9/00

(52) U.S. Cl. 343/746

(57) ABSTRACT

The present invention relates to an internal antenna for a handset and a design method thereof. The present invention provides an internal antenna for a handset and a design method thereof characterized in that a L/C element is attached to a slot line of an internal antenna, the attached L/C element is moved along the slot line, or the L/C element having a predetermined inductance/capacitance is attached and detached, thereby easily matching a resonant frequency.

### TECHNICAL FIELD

The present invention relates to an internal antenna for a handset, and more particularly, to an internal antenna for a handset and a design method thereof in which an inductive and/or capacitive element (Hereinafter, referred to as “L/C element”) is attached to a slot line of an internal antenna, or the attached L/C element is moved along the slot line, or the L/C element having a predetermined inductance/capacitance is attached and detached, thereby easily matching a resonant frequency.

### BACKGROUND ART

In recent years, as a portable handset, such as a portable phone, a portable digital assistance (PDA) and a wireless notebook computer, is being popularized, a consumer's demand for a terminal having various functions and designs is being increased. Accordingly, the portable wireless terminal is being not only gradually miniaturized, light-weighted and simplified, but also its importance of design is being more highlighted together with a function diversity.

In order to satisfy the consumer's demand, the design of the antenna essential to a handset body is of importance to the wireless handset.

The antenna is installed at one side of the handset body to function as a media when a wireless signal is transmitted and received between the wireless handset and an external wireless station. Therefore, the antenna is advanced and used in various types such as a fix type, a retractable type, a mount type, a rotary type, and a snap-in type so as to enhance a performance.

In particular, as the importance of the design is highlighted together with the function diversity, a built-in antenna (Hereinafter, referred to as “internal antenna”), which is wholly installed inside of the handset body without protruding outside of the handset body, has been developed for the wireless handset.

The internal antenna is installed inside of the handset body and electrically connected on a main board to perform its proper function. Compared with a conventional protrusive or external antenna, it is difficult to is design and manufacture the internal antenna.

Specifically, since the antenna body is wholly installed inside of the handset body, it is very difficult to constantly maintain a frequency characteristic in assembly and a frequency characteristic in a complete product whose the handset body is entirely made airtight.

Accordingly, there is a drawback in that the matching of the resonant frequency deteriorates a productivity of the internal antenna.

### DISCLOSURE OF INVENTION

### Technical Problem

Accordingly, the present invention is directed to an internal antenna for a handset and a design method thereof that substantially obviate one or more of the problems due to limitations and disadvantages of the related art.

An object of the present invention is to provide an internal antenna for a handset and a design method thereof in which a resonant frequency can be easily matched.

Another object of the present invention is to provide an internal antenna for a handset and a design method thereof in which the internal antenna having a desired frequency characteristic can be easily designed and manufactured, thereby stably maintaining a performance of the internal antenna while enhancing productivity.

### Technical Solution

To achieve these and other advantages and in accordance with the purpose of the present invention, as embodied and broadly described, there is provided an internal antenna for a handset, characterized in that at least one inductive (L) and/or capacitive (C) element (L/C element) is attached to a slot line of the antenna to match a resonant frequency of the antenna.

Preferably, the attached L/C element is moved along the slot line to match the resonant frequency, or the L/C element having a predetermined inductance/capacitance is attached and detached to match the resonant frequency.

In another aspect of the present invention, there is provided a method of designing an internal antenna for a handset, characterized in that at least one inductive (L) and/or capacitive (C) element (L/C element) is attached to a slot line of the antenna to match a resonant frequency of the antenna.

Preferably, the attached L/C element is moved along the slot line to match the resonant frequency, or the L/C element having a predetermined inductance/capacitance is attached and detached to match the resonant frequency.

### ADVANTAGEOUS EFFECTS

According to the present invention, there is an effect in that a LC element is attached to a slot line of an internal antenna and the attached L/C element is moved along the slot line to easily match a resonant frequency, so that the internal antenna having a desired frequency characteristic can be easily designed and manufactured, thereby stably maintaining a performance of the internal antenna while enhancing productivity.

### BRIEF DESCRIPTION OF DRAWINGS

FIG. 1 is a view illustrating an internal antenna for a handset and a design method thereof according to an embodiment of the present invention;

FIG. 2 is a view illustrating measurement positions of a L/C element, at which a frequency characteristic of an internal antenna is measured;

FIGS. 3 to 7 are views illustrating standing wave ratios respectively measured by moving a L/C element along measurement positions of FIG. 2;

FIG. 8 is a view illustrating a measurement position of a L/C element, at which a frequency characteristic of an internal antenna is measured depending on a variation of an inductance and/or a capacitance;

FIGS. 9 to 16 are views illustrating standing wave ratios respectively measured by varying an inductance and/or a capacitance at a measurement position of FIG. 8;

FIG. 17 is a view illustrating measurement positions of a plurality of L/C elements, at which a frequency characteristic of an internal antenna is measured depending on a variation of an inductance and/or a capacitance; and

FIGS. 18 to 20 are views illustrating standing wave ratios respectively measured by varying an inductance and/or a capacitance at a measurement position of FIG. 17.

### BEST MODE FOR CARRYING OUT THE INVENTION

Hereinafter, preferred embodiments of the present invention will be described in detail with reference to accompanying drawings.

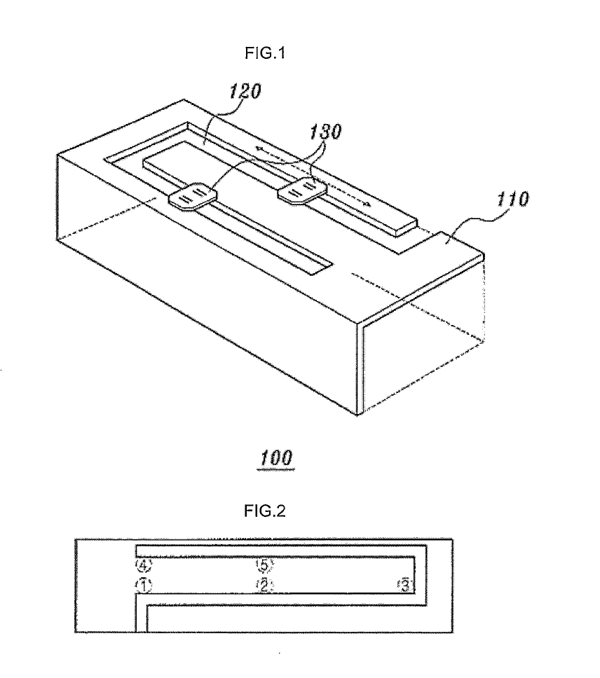

FIG. 1 is a view illustrating an internal antenna for a handset and a design method thereof according to an embodiment of the present invention.

As shown in FIG. 1, the internal antenna 100 includes a flat-shaped antenna body 110 having a predetermined meander line formed by a slot 120.

In a general manner, the internal antenna 100 adjusts a length and a width of the meander line of the antenna body 110 by using the slot 120, to adjust a resonant frequency. For a minute adjustment, an inductive and/or capacitive element (Hereinafter, referred to as “L/C element”) 130 is attached along the slot 120.

Specifically, the inventive internal antenna 100 includes the L/C element 130 for selecting an inductance (L) and/or a capacitance (C), to obtain a desired frequency characteristic without a pattern limitation of the slot 120 and the antenna body 110.

Further, the L/C element 130 can be moved and adjusted along the slot 120 to easily match the resonant frequency of the antenna.

Hereinafter, the inventive internal antenna for the handset and the design method thereof are in detail described through modified examples below.

(1) Characteristic Measurement when the L/C Element is Moved Along the Slot.

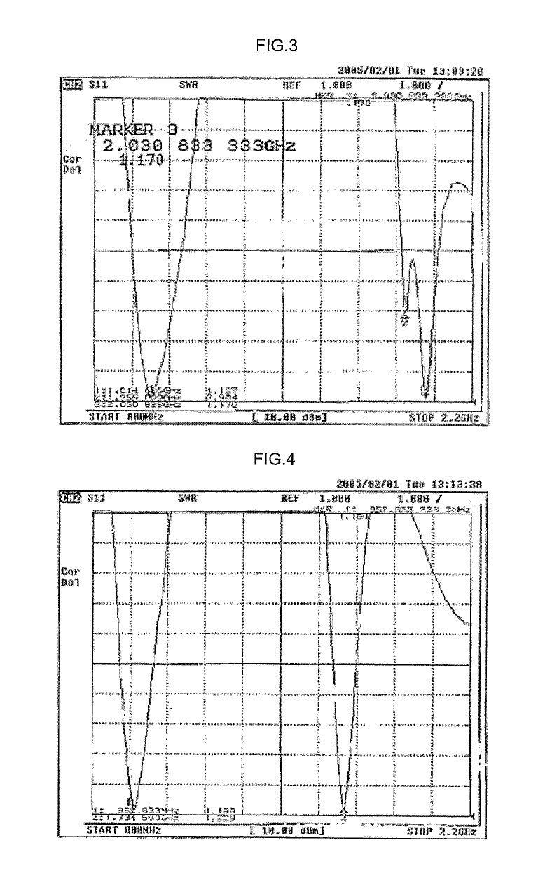

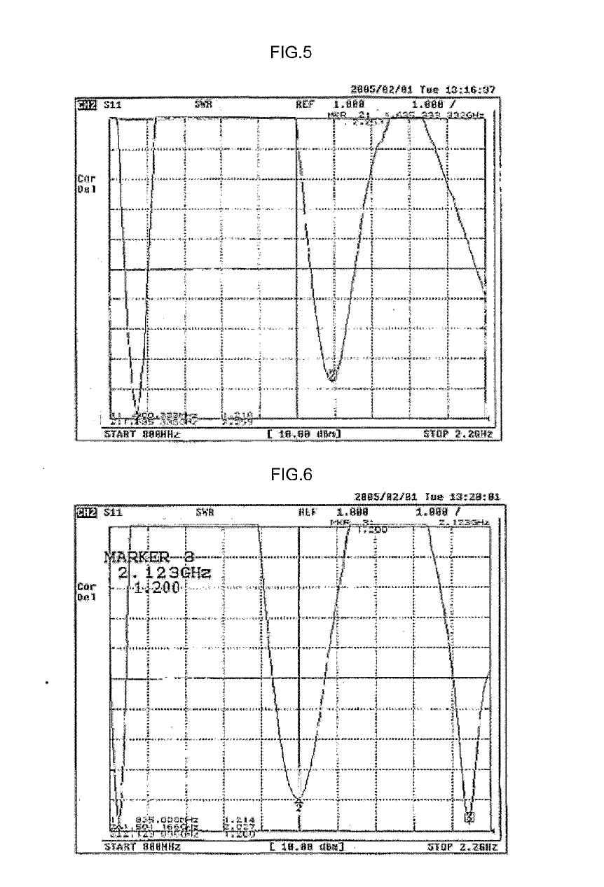

FIG. 2 is a view illustrating measurement positions of the L/C element, at which the frequency characteristic of the internal antenna is measured. FIGS. 3 to 7 are views illustrating standing wave ratios (SWR) respectively measured by moving the L/C element along the measurement positions of FIG. 2.

In an experiment method, the standing wave ratios of the internal antenna were measured with the inductive element having an inductance (L) of 1 nH and the L/C element attached at five points along the slot as shown in FIG. 2.

FIGS. 3 to 7 illustrate the standing wave ratios of the internal antenna where the L/C element is positioned at a measurement point 1, a measurement point 2, a measurement point 3, a measurement point 4 and a measurement point 5.

As shown in FIGS. 3 to 7, the L/C element can be changed in position, thereby easily adjusting the resonant frequency and not only easily adjusting a bandwidth at each resonant frequency, but also adjusting the number of the resonant frequency.

(2) Characteristic Measurement when the Inductance and/or the Capacitance are/is Varied at the Same Position of the Slot.

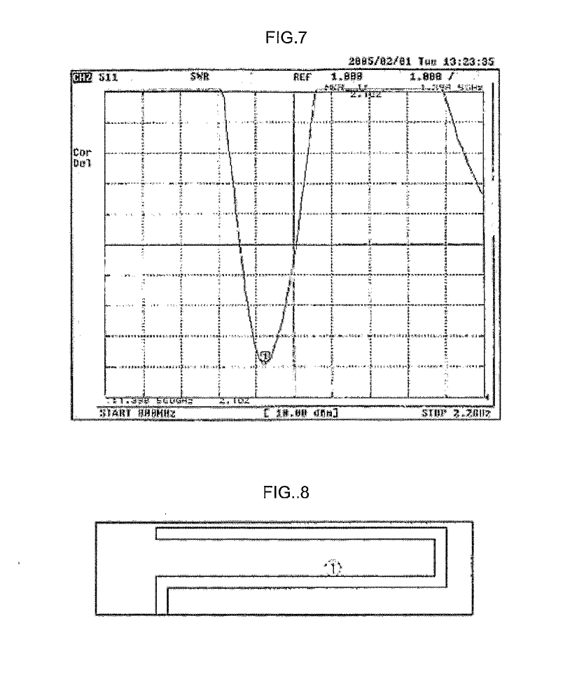

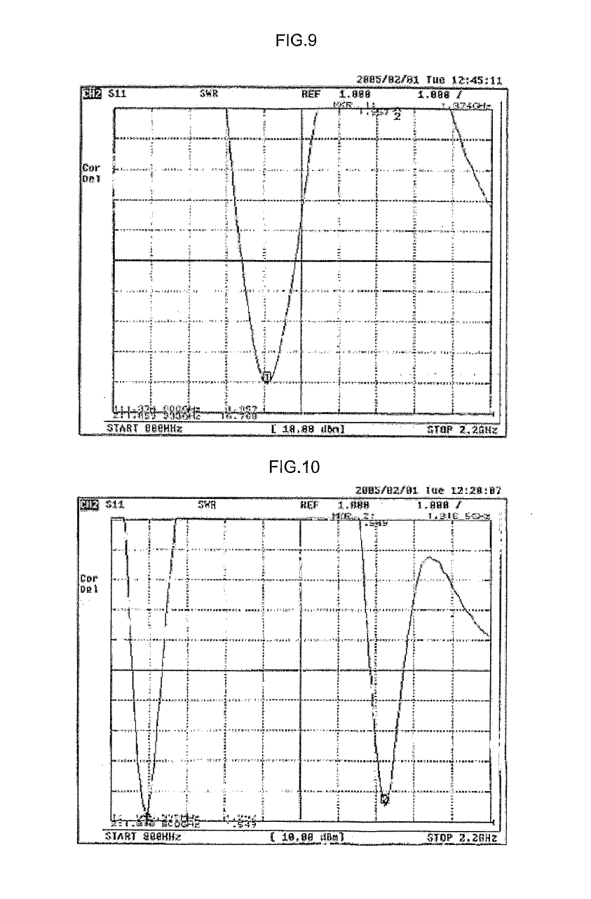

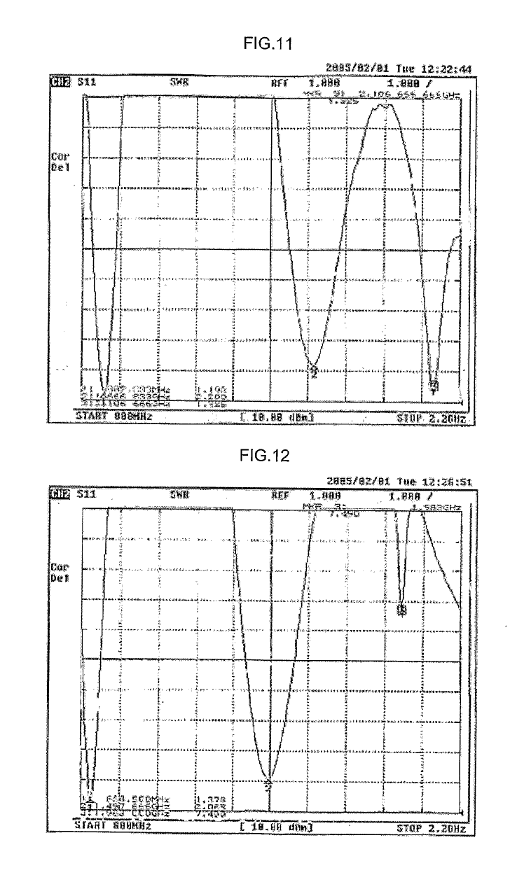

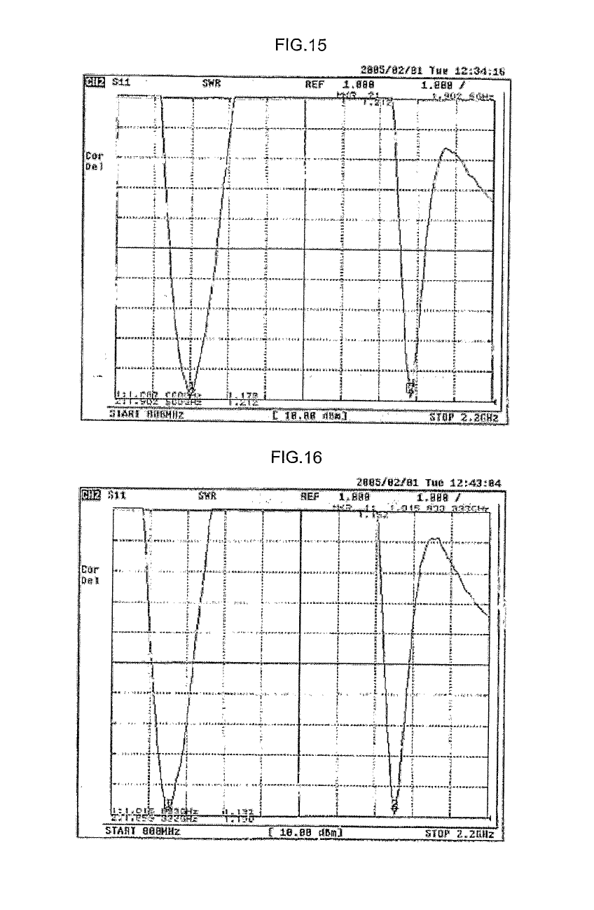

FIG. 8 is a view illustrating the measurement position of the L/C element, at which the frequency characteristic of the internal antenna is measured depending on the variation of the inductance and/or the capacitance. FIGS. 9 to 16 are views illustrating standing wave ratios respectively measured by varying the inductance and/or the capacitance at the measurement position of FIG. 8.

In an experiment method, the standing wave ratios of the internal antenna were measured in case where the L/C element is not attached at the measurement point 1 of FIG. 8 and in case where the L/C element having different inductance (L) and/or capacitance (C) is attached at the measurement point 1 of FIG. 8.

FIGS. 9 to 12 illustrate the standing wave ratios of the internal antenna where the L/C element is not attached and in case where the inductive element having an inductance (L) of 1nH, 10nH or 22nH is attached.

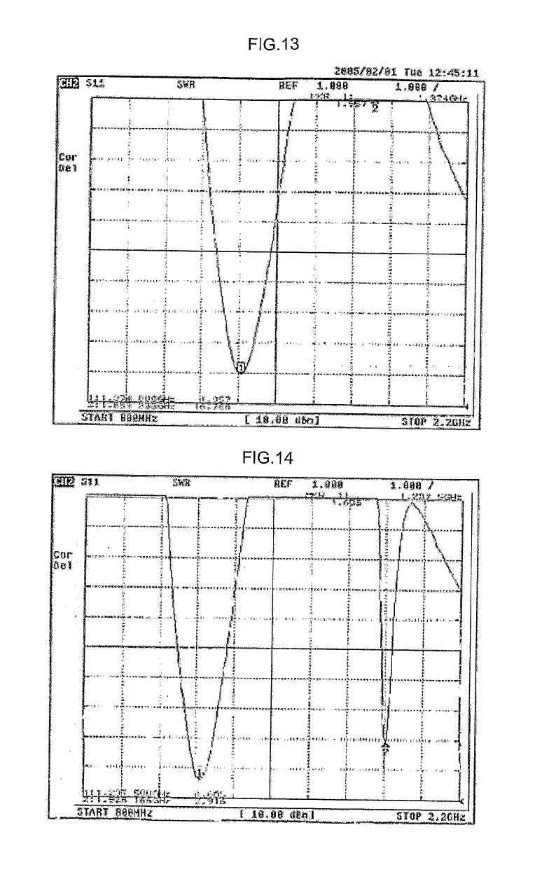

Further, FIGS. 13 to 16 illustrate the standing wave ratios of the internal antenna where the L/C element is not attached and in case where the capacitive element having an capacitance (C) of 0.5 pF, 2 pF or 4 pF is attached.

As shown in FIGS. 9 to 12 and 13 to 16, the inductance and the capacitance are varied, thereby easily adjusting the resonant frequency at a frequency of 1 GHz and not only easily adjusting the bandwidth at each resonant frequency, but also adjusting the number of the resonant frequency.

(3) Characteristic Measurement when a Plurality of L/C Elements are Attached to the Slot.

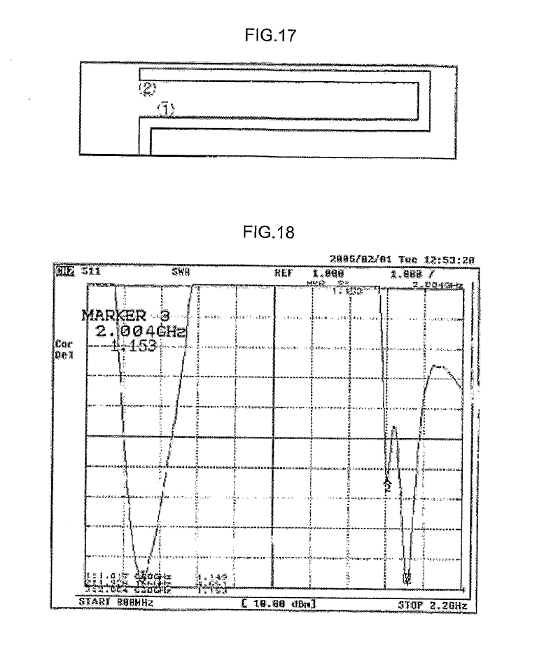

FIG. 17 is a view illustrating measurement positions of the plurality of L/C elements, at which a frequency characteristic of an internal antenna is measured depending on the variation of the inductance and/or the capacitance. FIGS. 18 to 20 are views illustrating standing wave ratios respectively measured by varying the inductance and/or the capacitance at the measurement position of FIG. 17.

In an experiment method, the standing wave ratios were measured with two L/C elements attached to the slot of FIG. 17 and with the inductance (L) of 1 nH or 22nH set at the measurement point 1 and the capacitance (C) of 1 pF set at the measurement point 2.

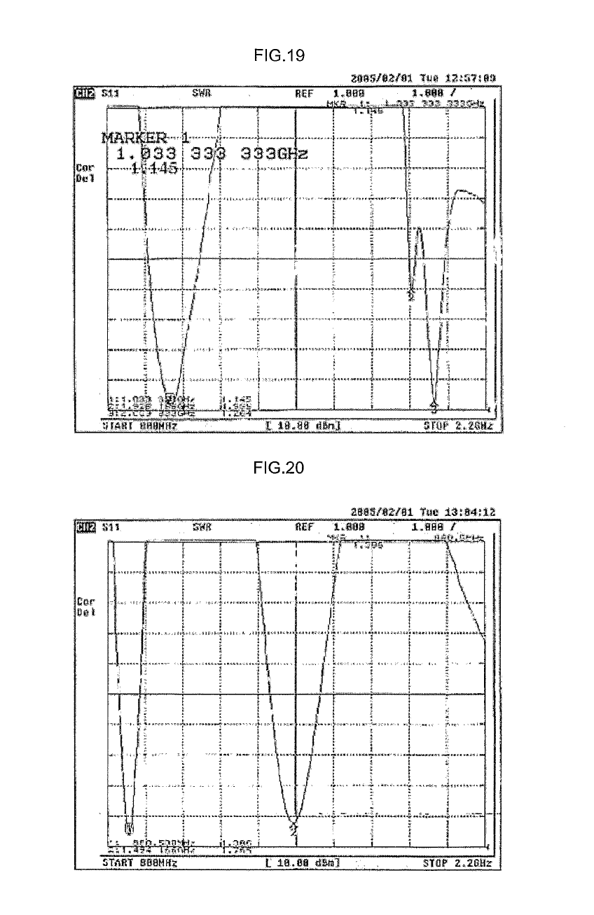

In FIG. 18, the standing wave ratio of the internal antenna was measured with the L/C element attached only at the measurement point 1. In FIG. 19, the standing wave ratio of the internal antenna was measured with the L/C element having the inductance (L) of 1nH at the measurement point 1 and the capacitance (C) of 1 pF at the measurement point 2. In FIG. 20, the standing wave ratio of the internal antenna was measured with the L/C element having the inductance (L) of 22nH at the measurement point 1 and the capacitance (C) of 1 pF at the measurement point 2.

As shown in FIGS. 18 to 20, the plurality of L/C elements are attached and their inductance and capacitance are varied, thereby easily adjusting the resonant frequency and not only easily adjusting the bandwidth at each resonant frequency, but also adjusting the number of the resonant frequency at a predetermined bandwidth.

### INDUSTRIAL APPLICABILITY

As described above, the internal antenna for the handset and the design method thereof according to the present invention facilitate the matching of the resonant frequency, thereby not only facilitating the design and the manufacture of the internal antenna having the desired frequency characteristic, but also stably maintaining the performance of the internal antenna while enhancing productivity.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. An internal antenna for a handset,
wherein at least one inductive (L) and/or capacitive (C) element (LIC element) is attached to a slot line of the antenna to match a resonant frequency of the antenna.

2. The antenna according to claim 1, wherein the attached L/C element is moved along the slot line to match the resonant frequency.

3. The antenna according to claim 1, wherein the L/C element having a predetermined inductance/capacitance is attached and detached to match the resonant frequency.

4. A method of designing an internal antenna for a handset,
wherein at least one inductive (L) and/or capacitive (C) element (L/C element) is attached to a slot line of the antenna to match a resonant frequency of the antenna.

5. The method according to claim 4, wherein the attached L/C element is moved along the slot line to match the resonant frequency.

6. The method according to claim 4, wherein the L/C element having a predetermined inductance/capacitance is attached and detached to match the resonant frequency.

7. The method according to claim 5, wherein the L/C element having a predetermined inductance/capacitance is attached and detached to match the resonant frequency.

8. The antenna according to claim 2, wherein the L/C element having a predetermined inductance/capacitance is attached and detached to match the resonant frequency.
